(19) United States
(12) Patent Application Publication
(10) Pub. No.: US 2005/0229955 A1
(43) Pub. Date: Oct. 20, 2005

(54) Device for the generating and controlling of the cleaning agent flow in a process chamber

(75) Inventors: Jean-Pierre Desbiolles, Cruseilles (FR); Johann Parrochon, Annecy Le Vieux (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/004,882

(22) Filed: Dec. 7, 2004

(30) Foreign Application Priority Data
Dec. 9, 2003 (FR) 03 14 378

(51) Int. Cl. C25F 1/00; B08B 6/00; C23F 1/00

(52) U.S. Cl. 134/104.2; 134/1.1; 134/10; 156/345.29; 216/58

(57) ABSTRACT

According to the invention, a process chamber (1), equipped with a vacuum line (4) with a main pump unit (3), is associated with a recirculation device (9) that collects part of the process chamber (1) outlet gases to filter them using a trap (11) and to reinject them via a process chamber (1) inlet (22). The recirculation device (9) is characterized by pressure sensor devices (7, 14) to measure the recirculation flow without causing pressure drops, so that the gas pressure in the recirculation device (9) remains low. This guarantees the device's operating safety, while improving its recirculation capacity.

The present invention concerns the means for controlling the cleaning agent flow in a process chamber during the chamber cleaning stages.

During the production of microelectrical or electromechanical microsystem (MEMS) components, semi-conductor wafers are treated in process chambers containing a low pressure gaseous atmosphere. Some process stages in process chambers use deposit gas plasmas that produce deposits on the semi-conductor wafer being treated. These deposits are also made on the walls of the process chambers, however.

The process chambers must therefore be periodically cleaned using appropriate gas cleaning agents under a controlled atmosphere, usually at low pressure.

To make sure that the gas cleaning agents are effective, their flow must be controlled, while maintaining an appropriate gas pressure in the process chamber.

To maintain this appropriate gas pressure, the process chambers are usually connected to a vacuum line comprising one or several vacuum pumps that collect the gases from the process chamber and evacuate them into the atmosphere. The vacuum line usually includes a process chamber outlet control valve to control the gas pressure inside the process chamber.

During the stages involved in cleaning process chambers to remove silicon oxide deposits resulting from previous processes (for example, SACVD, PECVD and HDPCVD), a cleaning gas is used that is cracked by plasma either directly in the process chamber, or in an adjoining chamber that communicates with the process chamber. In any case, the cracking by plasma requires a low pressure atmosphere in the process chamber.

Until now the flow of cleaning gas into the process chamber has been controlled by controlling the injecting of cleaning gas into the process chamber.

The idea is that maintaining a low pressure in the process chamber requires the constant evacuating of gases via the vacuum line. This results in the constant evacuating of cleaning gases and a high consumption of cleaning gas, which is a costly and a pollutant agent.

For example, when silicon oxide is cleaned away using nitrogen trifluoride (NF₃), the atomic fluorine dissociated in the plasma combines with the silicon oxide through the reaction:
4F+SiO₂→SiF₄+O₂

After the cracking of the nitrogen trifluoride by the plasma, a large proportion of the fluorine atoms do not react with the silicon oxide and recombine into F₂ fluorine molecules. This means that during a cleaning stage, much of the cleaning gas' cleaning potential is unused as it is evacuated into the atmosphere.

To avoid this loss, several solutions have already been proposed in document US 2003/036272 A1, whose principle is to collect the gas mixture at the process chamber outlet, to filter this mixture to extract the products resulting from cleaning and then to reinject the filtered mixture into the plasma source in addition to a cleaning glass flow injected into the plasma source. The document refers to the need to know and control the recirculation flow and to this end suggests placing a flow controller (MFC) in series in the recirculation line. Owing to the presence of the flow controller, a pressure of more than 100 Torr is produced in the recirculation line, which is necessary, according to this document, to extract products resulting from cleaning, such as silicon tetrafluoride (SiF₄).

Of the means proposed for extracting products resulting from cleaning in the recirculation line, the document suggests using cryogenic trapping, and periodically regenerating the cryogenic trap to eliminate the products that it condenses. The document therefore suggests either pumping the recirculation line through the process chamber after the cleaning stage, or evacuating the cleaning products during this cleaning stage in the form of a liquid, which requires a pressure of around 100 to 600 Torr.

The recirculation solution proposed in the document is not satisfactory for several reasons.

First of all, several operating faults were observed under certain conditions of use, following the corroding of the pumps.

Secondly, the regenerating of the cryogenic trap through the process chamber may pollute the process chamber itself, which is the opposite of the aim sought. The regeneration stage also makes the process chamber unavailable for a considerable period of time, which reduces the installation's overall yield.

The problem tackled by the present invention is the developing of a new device structure for generating and controlling the cleaning agent flow in a process chamber presenting a satisfactory operating safety level and presents no risk of corrosion.

The invention is also aimed at improving the system's recirculation capacity, in particular by preventing the regenerating of the cryogenic trap from disrupting the process chamber's operation.

Accordingly, the invention results from the surprising observation according to which the operating faults of known devices are apparently owing to too high a gas pressure in certain sections of the recirculation line, and the lowering of this pressure causes a noticeable reduction in the risk of corrosion and operating anomalies.

To achieve these and other aims, the invention therefore proposes a device for the generating and controlling of the cleaning agent flow, which can be used with a process chamber to ensure its cleaning through a gas cleaning agent, comprising a recirculation device suitable for collecting gases leaving the process chamber and for filtering and reintroducing them into the process chamber; the recirculation device is structured so that, at all parts of its journey through the recirculation device, the recycled gases remain at the low pressure reigning in the process chamber to a noticeable degree. This means that the recycled gases remain at a pressure lower than a few Torrs (a few tens of Pascals), that is advantageously lower than around 20 Torr (around 260 Pascals).

According to a practical application, the device for generating and controlling the cleaning agent flow comprises:
A recirculation line into which a multi-stage recirculation pump is inserted,
A recirculation pump intake connected to the process chamber,
A bypassed outlet at the discharge of the pump's first stage, the bypassed outlet being connected to the recirculation line,
A return line connected between the discharge of the recirculation pump's last stage and the bypassed outlet,
A discharge line connected between the discharge of the recirculation pump's last stage and the discharge of the process chamber's main pump unit.

The device also comprises all-or-nothing valves, controlled by a control device to isolate the recirculation device from the process chamber during the trap regeneration stages.

According to another practical application, the device for generating and controlling the cleaning agent flow comprises a recirculation device including a recirculation line into which are inserted a recirculation pump, a trap to selectively retain the products issuing from the cleaning of the process chamber, and a flow measuring device for measuring the gas recirculation flow downstream of the trap; the recirculation pump is driven by a variable speed motor; a command controller controls the speed of the recirculation pump's driving motor; the flow measuring device includes a suitable second pressure sensor in a recirculation line zone downstream of the trap, and a suitable first pressure sensor downstream of the second pressure sensor in the recirculation line or the process chamber; a flow controller receives the information from the first and second pressure sensors and contains a recorded program and recorded comparison data to determine the recirculation flow from said information from the first and second recirculation sensors.

The presence of the pressure sensors in the recirculation line does not cause a pressure drop, meaning that the gases may flow freely in the recirculation line. The cryogenic trap does not cause a noticeable pressure drop either. The recirculation device does not therefore present any gas overpressure zones.

The recorded comparison data are usually specific to the conductance of the recirculation system and the way in which the recirculation system is connected to the client system. According to the invention, the recorded program might therefore advantageously contain a learning sequence by means of which the flow controller records two successive sets of pressure measurements performed by the first pressure sensor and the second pressure sensor respectively for a series of known values for gas flows passing through the recirculation device.

As an alternative, or in addition, the command controller might control the speed of the recirculation pump's driving motor in order to establish a recirculation flow according to a predetermined flow value curve.

In this case, the command controller that controls the recirculation pump is also the flow measuring device flow controller. The combined controller receives a changing reference value in the form of a flow value curve and controls the recirculation pump's motor so that the recirculation flow values measured follow the changing reference value.

As an alternative, the command controller that controls the recirculation pump may receive a changing recirculation flow reference value, which it translates through a program in terms of the speed of the recirculation pump in order to control the speed of the recirculation pump's driving motor.

In this case, the recirculation pump command controller program may contain a learning sequence that controls the rotation of the recirculation pump's driving motor according to a succession of rotation speeds, and records the corresponding recirculation flow values measured from the flow controller or the pressure sensors, in order to define the relationship between the recirculation pump's rotation speed and the recirculation flow's value.

According to another alternative, the recirculation pump command controller may contain a recorded program sequence that determines the recirculation flow value necessary to keep the total cleaning agent flow in the process chamber constant if the cleaning agent flow directly injected into the process chamber varies.

According to an advantageous application of the invention, which improves the recirculation capacity, the device comprises a cryogenic trap placed upstream of the recirculation pump.

All-or-nothing valves controlled by a control device may be prefered, to isolate the recirculation device from the process chamber during the cryogenic trap regeneration stages.

This prevents the need for gases from the cryogenic trap regeneration process to be passed through the process chamber.

The objective of the invention is also a process for cleaning a process chamber agent associated with a plasma source, using a gas cleaning agent, by means of the device for the generating and controlling of the cleaning agent flow described previously, comprising a process chamber utilization stage, a process chamber cleaning stage, and a device regeneration stage. According to this process, the regeneration stage may take place at the same time as the utilization stage. Consequently, the regeneration stage may take place during each utilization stage. Regeneration is easier to implement and may thus be as frequent as the process stages other than the cleaning stages. This means that not many deposits are accumulated in the cryogenic trap.

During the cleaning stage, a minority of the recycled gases move up through all the pump's stages, leave through the return line and join the bypassed outlet, and the majority of the recycled gases pass directly out of the bypassed outlet.

During the regeneration stage, the valve is open and the pump bleeds the recirculation system, extracting the products resulting from cleaning condensed on the cryogenic trap and discharging them into the line.

Other objectives, characteristics and benefits of the present invention will emerge from the following description of the preferred applications made in connection with the figures appended, in which:

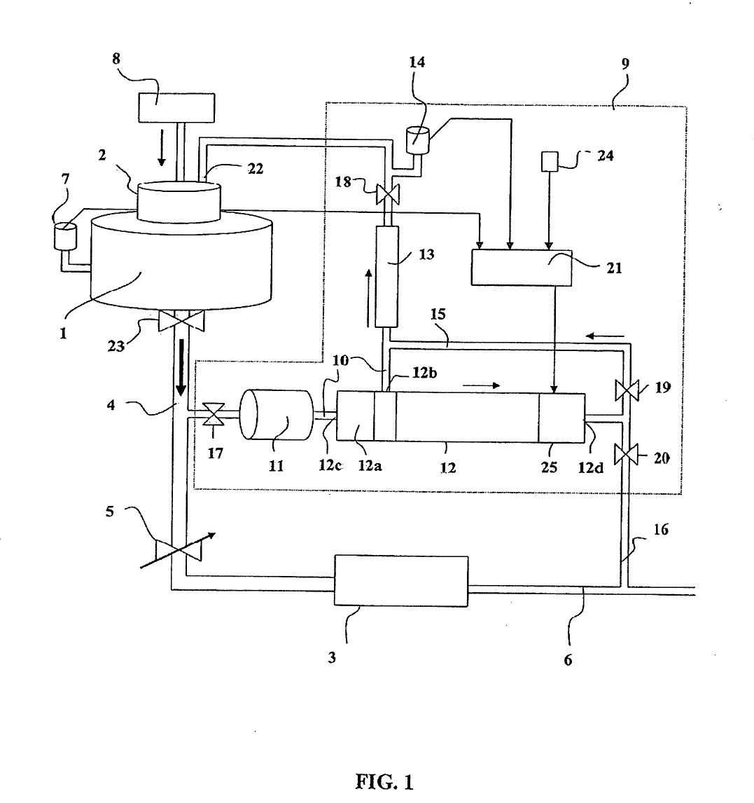

FIG. 1 schematically represents the structure of the devices for the generating and controlling of the cleaning agent flow in a process chamber; and

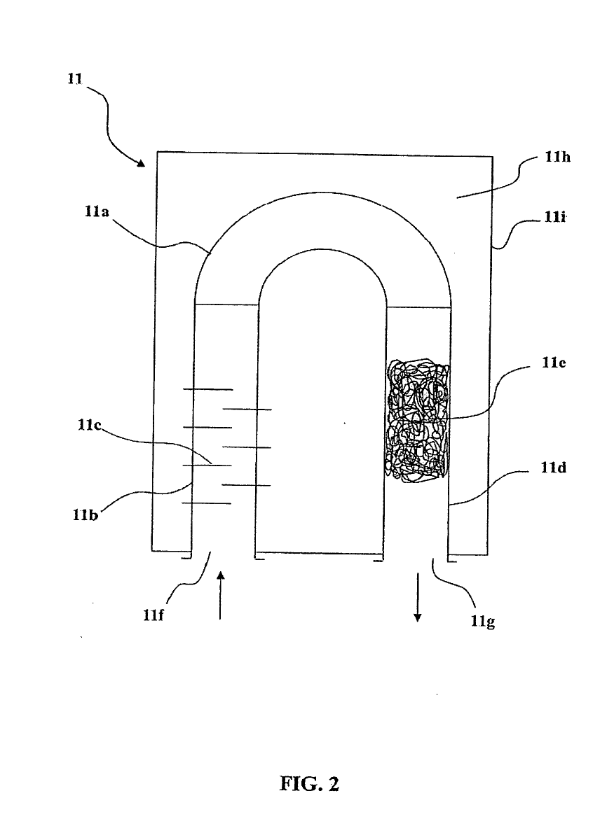

FIG. 2 is a sectional schematic view of a cryogenic trap suitable for the present invention.

In the approach illustrated on FIG. 1, a process chamber 1 is associated with a plasma source 2, which generates a plasma in the process chamber 1, according to the process' stages. A vacuum line, connected to the process chamber 1, includes a main pump unit 3 connected to an outlet of the process chamber 1 via a vacuum line 4 and a variable opening control valve 5. The main pump unit 3 discharges gas into the atmosphere through an outlet line 6.

The pressure in the process chamber 1 is measured using a first pressure sensor 7, which sends the pressure signals to a control device 21, which itself controls the control valve 5 in order to control the pressure in the process chamber 1.

Alternatively, the control valve 5 may be absent if the pressure in the process chamber 1 is controlled by the varying of the pumping speed in the main pump unit 3.

A cleaning gas source 8 is used that is suitable for injecting an appropriate cleaning gas flow into the plasma source 2 during the process chamber cleaning stages.

In the plasma source 2, the cleaning gas is cracked in order to release the active atoms that are the cleaning agents. The active atoms react with the solid deposits present on the walls of the process chamber 1, producing gas compounds that are eliminated through pumping by means of the main pump unit 3.

The device according to the invention comprises a recirculation system 9, surrounded by a dotted line on the figure.

The recirculation system 9 comprises a recirculation line 10 connected both to the vacuum line 4 at the outlet of the process chamber 1, and to an inlet 22 of the process chamber 1.

In the recirculation line 10 can be found a trap 11, which is preferably a cryogenic trap, followed by a recirculation pump 12, whose rotation is controlled by a motor 25, then possibly a filter 13, and a second pressure sensor 14 suitable for measuring the gas pressure inside the recirculation line 10 downstream of the recirculation pump 12 or downstream of the filter 13, if this is present, but away from the inlet 22 in the process chamber 1.

The pressure sensors 7 and 14 are gauges suitable for pressure measurements within the range of operating pressures reigning in the recirculation line 10. Gauges from the “Baratron” range proposed by the company MKS Instruments, USA may be used, for example.

The recirculation pump 12 is a multi-stage pump, with a first stage 12a, whose intake is connected to the outlet of the trap 11 that includes, at its discharge, a bypassed outlet 12b. The recirculation line 10 passes through the first stage 12a of the recirculation pump 12, between the intake 12c and the bypassed outlet 12b.

At the discharge 12d of the last stage of the recirculation pump 12, a return line 15 is connected, which returns to the bypassed outlet 12b, and a discharge line 16 is connected, which is itself connected to the vacuum line outlet line 6, in other words to the discharge of the main pump unit 3 of the process chamber 1.

An all-or-nothing valve 17 is placed in the recirculation line 10 before the trap 11. Another all-or-nothing valve 18 is placed in the recirculation line 10 downstream of the filter 13. The all-or-nothing valve 18 may be upstream or downstream of the second pressure sensor 14. Another all-or-nothing valve 19 is placed in the return line 15, and a fourth all-or-nothing valve 20 is placed in the discharge line 16.

The control device 21 manages the all-or-nothing valves 17, 18, 19 and 20, according to the cleaning process' steps, and also controls the speed of the driving motor 25 of the recirculation pump 12, according to the pressure signals received from the first pressure sensor 7, the pressure signals received from the second pressure sensor 14, and to a flow reference value 24.

The control device 21 therefore contains data recorded in a memory, and an appropriate program, to control the various cleaning agent flow generation and control device units in order to obtain a satisfactory cleaning gas flow in the process chamber 1.

The data recorded in the control device 21 first of all includes recorded comparison data that allow the recirculation flow in the recirculation line 10 to be determined according to the information given by the first pressure sensor 7 and the second pressure sensor 14.

These comparison data are gathered during a prior recirculation line 10 learning procedure. During this procedure, a known flow of gas is injected from the cleaning gas source 8, and the recirculation pump 12 is run in a reverse direction, so that the gas injected circulates from the outlet of the recirculation system 9 to its inlet, first of all passing through the filter 13, then through the recirculation pump 12 and the trap 11, before finally being evacuated by the main pump unit 3. The all-or-nothing valves 17, 18 and 19 are open, while the all-or-nothing valve 20 is closed.

During this line learning stage, the process chamber 1 is isolated by an isolation valve 23 in a closed position. An algorithm contained in the control device 21 program then records the difference between the pressures indicated by the two pressure sensors 7 and 14 for several flow values. The first pressure sensor 7 gives the pressure at the inlet 22 of the process chamber 1, and the second pressure sensor 14 gives the pressure at the second measuring point in the recirculation line 10. The result is a curve representing the pressure differences according to the flow circulating in this part of the recirculation line 10, in other words between the inlet 22 and the second pressure sensor 14.

The properties of the recirculation pump 12 are then determined through a second learning stage.

During this second stage, a gas flow is injected from the gas source 8 and the recirculation pump 12 is run in a forward direction, to recirculate the gases in the recirculation line 10 from the trap 11 to the second pressure sensor 14. The isolation valve 23 is open, as well as the all-or-nothing valves 17, 18 and 19. The all-or-nothing valve 20 is closed. The pressure in the process chamber 1 is adjusted to the usual values corresponding to the stages in the cleaning of the process chamber 1 by the control valve 5. The value of the flow circulating between the second pressure sensor 14 and the inlet 22 in the process chamber 1 is therefore determined, for several recirculation pump 12 driving speed values, thanks to the previous calibration of the recirculation line 10. The result is a curve representing the flow recirculating in the recirculation system 9 according to the driving speed of the recirculation pump 12.

Note that the first pressure sensor 7 must be positioned, in the process chamber 1, so as to measure the pressure at the inlet 22 of the process chamber 1.

Thanks to this recirculation system 9 structure, which does not include a flow rate measuring device, which cause an overpressure, the gas flow circulating in the recirculation line 10 is at all points at the low pressure reigning in the process chamber 1 to a noticeable degree. Corrosive gases, such as fluorine, are in this way kept at a low pressure, lower than or equal to 20 Torr, guaranteeing safety.

If the data obtained through the previous learning stages is recorded in the control device 21, the assembly may control a cleaning stage of the process chamber 1. The valve 23 is in this case open and the pressure in the process chamber 1 is adjusted through the control valve 5, or through the varying of the pumping speed of the main pump unit 3. A cleaning gas flow is injected from the cleaning gas source 8, but this flow is lower than the standard flow necessary for a usual correct cleaning stage.

The difference between the standard flow and the flow actually injected is a quantity determined by the recirculation limits of the recirculation system 9. This difference corresponds to the cleaning gas saving made.

To ensure the recirculating of the cleaning gas, the valves 17, 18 and 19 are open, and the valve 20 is closed. The recirculation pump 12 runs in a forward direction in order to extract the gases from the vacuum line 4 and to reinject them into the plasma source 2 via the inlet 22.

A minority of the gas recirculating pass up through all the stages of the recirculation pump 12, while the majority pass directly through the bypassed outlet 12b. The return line 15 allows the gas that passes up through all the stages of the recirculation pump 12 to join the recirculation line 10. Consequently, no corrosive cleaning gases are compressed or heated inside the recirculation pump 12, which is a guarantee of safety.

For the rest, the cleaning stage implements the known processes for cleaning the process chamber 1 through a mixture of recirculation gas and injected gas, as described in document US 2003/036272 A1.

The trap 11 must be of a type that does not locally increase the cleaning gas pressure in the recirculation line 10, to optimize the system's safety.

A cryogenic trap 11 may be advantageously used, making sure that the cryogenic trap offers a maximum cold and gas exchange surface, without impeding the passage of the gas. As shown on FIG. 2, for example, a heat conducting line 11a may be used, with an upstream section 11b whose wall is crossed by the heat conducting vanes 11c, with a downstream section 11d filled with the stainless steel links 11e in contact with the line's wall. The line 11a is crossed by the recirculation flow, which penetrates through its upstream inlet 11f and leaves through the downstream outlet 11g. Between the inlet 11f and the outlet 11g, the line 11a is bathed on the outside in the liquid nitrogen 11h contained in a tank 11i.

The cryogenic trap 11 may be advantageously placed upstream of the recirculation pump 12. This arrangement allows cold, and therefore less dangerous, gas, to be sent into the recirculation pump 12.

During the cleaning stage, the cleaning products such as SiF₄ are condensed on the trap's cold surfaces. When the cleaning stage is complete, the valves 17, 18 and 19 are closed to isolate the process chamber 1 of the recirculation system 9, and another process stage may be carried out in the process chamber 1, independently of what is taking place in the recirculation system 9.

During this other process stage, the valve 20 is open and the recirculation pump 12 is run in a forward direction to bleed the recirculation system 9, extracting the cleaning products condensed on the cryogenic trap 11 and discharging them into the discharge line 16.

A nitrogen bleeder may be opened upstream of the cryogenic trap to increase the pressure and temperature inside the cryogenic trap 11, ensuring the circulating of a hot gas flow that contributes to the sublimation of the cleaning product deposits in the cryogenic trap 11.

A heating resistor may be used inside the cryogenic trap 11, powered to heat the cryogenic trap 11 and therefore further contribute to the sublimation of the cleaning product deposits.

Trap regeneration is therefore carried out in concurrent operation time, while other process stages take place, without the products evacuated during this regeneration again passing through the process chamber 1 or through the vacuum line 4. Regeneration is easier to implement and may thus be as frequent as the process stages other than the cleaning stages. This means that not many deposits are accumulated, which is another guarantee of safety should the deposit suddenly be accidentally sublimated.

It is also possible to regenerate the trap 11 during a process chamber cleaning stage, providing that this cleaning process is performed without recirculation.

The device according to the invention is also aimed at establishing and controlling the total cleaning agent flow present in the process chamber 1 during a cleaning stage.

According to the invention, the recirculation pump controller contains a recorded program sequence that determines the recirculation flow value necessary to keep the total cleaning agent flow constant in the process chamber if the cleaning agent flow directly injected into the process chamber 1 varies.

In this regard, the recirculation pump 12 should cause the recirculation not only of the active cleaning gas, but also of the gas products resulting from the cracking by plasma and the decomposition of the solid deposits to be eliminated from the process chamber 1 that have not been trapped in the trap 11.

The determination of the necessary flow must therefore be carried out taking this mixture into account, and an example is given below.

The gas flow in the recirculation line 10 is known. The aim of the program explained above lines is to calculate the recirculation flow necessary for the flow of fluorine atoms in the process chamber 1 to be the same as that in the case of standard cleaning, in other words without recirculation.

This requires the determining of the share of molecular fluorine in the recirculation flow. We assert that the share of atomic fluorine in this flow is minimal, as the recombination process F+F→F₂ is so advanced.

It is also necessary to know the proportion of fluorine used to clean the process chamber according to
4F+SiO₂SiF₄+O2

The figure of 13% fluorine used is a realistic example for a PECVD depositing process.

Finally, it is necessary to know the cleaning gas flow injected in the case of standard cleaning. Let's take the existing example of 1500 sccm of NF₃. If we suppose that the 1500 sccm are completely dissociated in the plasma source, a theoretical flow of 4500 sccm of fluorine atoms may be deduced. If 13% of these react with the silicon deposited on the process chamber's walls, and 87% recombine to form F₂ molecules, this implies chamber outlet flows of 1958 sccm of F₂ and 146 sccm of SiF₄.

For chamber cleaning to be as effective as in the standard case, there must therefore be a SiF₄ flow at the chamber outlet of 146 sccm, which implies a F₂ flow of 1958 sccm, given the balance between the fluorine recombination reaction and that of the attacking of the silicon deposited on the walls.

If we decide to save two thirds of the NF₃ injected in the standard case, we will inject only 500 sccm of NF₃ instead of 1500 sccm. This means a theoretical flow of 1500 sccm of fluorine atoms instead of 4500. The result is a 3000 sccm fluorine atom shortfall. These 3000 sccm will be provided through recirculation, which must therefore contain a flow of 1500 sccm of F₂.

As the flow of F₂ at the process chamber 1 outlet must be equal to 1958 sccm, and the flow of F₂ recirculating is 1500 sccm, the flow of F₂ pumped by the main pump and evacuated is 458 sccm.

It is then assumed that the main pump evacuates the gases regardless of their type. The proportions of the gases at the main pump's inlet will therefore be the same as those at the process chamber outlet. These gas proportions also correspond to the flow proportions.

There is therefore the following relationship for evacuation (1), which is valid for all four species: N₂, O₂, F₂ and SiF₄:
If ev.fl evacuated flow
out.fl=chamber outlet flow
rec.fl=recirculating flow
   F₂ ev.fl/total ev.fl=F₂ out.fl/total out.fl (1)

Consequently

$$\begin{matrix}{SiF}_{4} ev . fl = {F}_{2} ev . fl / {F}_{2} out . fl * {SiF}_{4} out . fl \\ = 458 / 1958 * 146 \\ = 34 sccm\end{matrix}$$

On the basis of the SiF₄ ev.fl and the SiF₄ out.fl, it may be deduced that the SiF₄ trap flow=112 sccm.

However, the pump evacuates the gas, which tends to increase the pressure in the system, leading to
Total ev.fl=balance of the reactions of the NF₃ injected+balance of the reactions of the F₂ recycled−trapped flow

Balance of the reactions of the NF₃ injected (500 sccm):
250 sccm of N₂
0.87*1500/2=652 sccm of F₂
0.13*1500/4=49 sccm of SiF₄
0.13*1500/4=49 sccm de O₂

The balance makes 1000 extra sccm of gas.

+balance of the reactions of the recycled F₂ (1500 sccm):
0.87*3000/2=1305 sccm of F₂
0.13*3000/4=98 scorn of SiF₄
0.13*3000/4=98 scorn of O₂

The balance is zero in terms of gas quantity.
trapped flow (112 sccm)

Leading to total ev.fl=1000-112=888 scorn

The O₂ and N₂ flows then need to be determined.

The following two relations apply for O₂:
O₂ out.fl=O₂ rec.fl+O₂ flow created in the chamber (2)
O₂ out.fl=O₂ rec.fl+O₂ ev.fl (2a)

The following two relations apply for N₂:
N₂ out.fl=N₂ rec.fl+(injection of NF₃)/2 (3)
N₂ out.fl=N₂ rec.fl+N₂ ev.fl (3a)

The O₂ ev.fl and the N₂ ev.fl may be deduced, then with the relation (1) come the N₂ out.fl and the O₂ out.fl, and finally the N₂ rec.fl and the O₂ rec.fl, writing in the relations (2) and (3) the N₂ out.fl and O₂out.fl values calculated.

This model is based on the assumption that even if the total flow passing into the chamber differs from the usual flow, the reactivity of the fluorine atoms with regard to the silicon will remain the same (13%).

Example: by applying the latter relations, the following flows may be obtained (in sccm)

| | Chamber outlet | Evacuation | Recirculation |
|---|---|---|---|
| F₂ | 1958 | 458 | 1500 |
| O₂ | 626 | 147 | 479 |
| N₂ | 1072 | 250 | 822 |
| SiF₄ | 146 | 34 | 112*(trapped) |
| Total | 3802 | 888 | 2801 |

The recirculation flow is 2800 sccm if we decide to save two thirds of the standard injection of NF₃.

The equations above can be used to determine each of the recirculation flow variation curve points necessary to obtain the required flow of cleaning products in the process chamber 1.

The present invention is not limited to the approaches that are explicitly described; it includes the different variants and generalizations that are within the scope of professionals in this field.

1. A device for the generating and controlling of the cleaning agent flow, which may be used on a process chamber (1) to ensure its cleaning by a gas cleaning agent, comprising a recirculation device (9) suitable for collecting the gases leaving the process chamber (1) and for filtering them and reintroducing them into the process chamber (1), characterized by the fact that the recirculation device (9) is structured so that, at all points of their journey through the recirculation device (9), the recycled gases remain at the low pressure reigning in the process chamber to a noticeable degree.

2. A device according to claim 1, in which the recycled gases remain at a pressure below around 20 Torr.

3. A device according to claim 1, comprising:
A recirculation line (10) into which a multi-stage recirculation pump (12) is inserted,
A recirculation pump (12) intake (12c) connected to the process chamber (1),
A bypassed outlet (12b) at the discharge of the first stage (12a) of the pump (12), the bypassed outlet (12b) being connected to the recirculation line (10),
A return line (15) connected between the discharge (12d) of the last stage of the recirculation pump (12) and the bypassed outlet (12b),
A discharge line (16) connected between the discharge (12d) of the last stage of the recirculation pump (12) and the discharge of the process chamber's (1) main pump unit (3).

4. A device according to claim 3, comprising all-or-nothing valves (17, 18, 19, 20), controlled by a control device (21) to isolate the recirculation device (9) from the process chamber (1) during the trap regeneration stages (11).

5. A device according to claim 1, in which the recirculation device (9) comprises a recirculation line (10) into which are inserted a recirculation pump (12), a trap (11) to selectively retain the products resulting from the cleaning of the process chamber (1), and a flow measuring device to measure the gas recirculation flow downstream of the trap (11), in which:
The recirculation pump (12) is driven by a variable speed motor (25),
A command controller (21) controls the speed of the recirculation pump's driving motor (25),
The flow measuring device comprises a suitable second pressure sensor (14) in a recirculation line (10) zone downstream of the trap (11), and a suitable first pressure sensor (7) downstream of the second pressure sensor (14) in the recirculation line (10) or in the process chamber (1),
A flow controller (21) receives the information from the first (7) and second (14) pressure sensors and contains a recorded program and recorded comparison data in order to determine the recirculation flow from said information from the first and second recirculation sensors (7, 14).

6. A device according to claim 5, in which the recorded program contains a learning sequence through which the flow controller (21) controls two successive sets of pressure measurements made by the first pressure sensor (7) and the second pressure sensor (14) respectively for a series of known values for gas flows passing through the recirculation device (9).

7. A device according to claim 5, in which the command controller (21) controls the speed of the recirculation pump's (12) driving motor (25) in order to establish a recirculation flow according to a predetermined flow value curve.

8. A device according to claim 7, in which the command controller (21) that controls the recirculation pump (12) is also the flow controller (21) of the flow measuring device, which combined controller (21) receives a changing reference value in the form of a flow value curve and controls the recirculation pump's (12) motor (25) so that the recirculation flow values measured follow the changing reference value.

9. A device according to claim 7, in which the command controller (21) that controls the recirculation pump (12) receives a changing recirculation flow reference value, which it translates through a program in terms of the recirculation pump's (12) speed to control the speed of the recirculation pump's (12) driving motor (25).

10. A device according to claim 9, in which the recirculation pump's (12) command controller program (21) contains a learning sequence that controls the rotation of the recirculation pump's (12) driving motor (25) according to a succession of rotation speeds, and that records the corresponding recirculation flow values measured from the flow controllers (21) or the pressure sensors (7, 14) in order to define the relation between the recirculation pump's (12) rotation and the recirculation flow value.

11. A device according to claim 9, in which the recirculation pump (12) command controller (21) contains a recorded program sequence that determines the recirculation flow value necessary to keep the total cleaning agent flow in the process chamber (1) constant if the cleaning agent flow directly injected into the process chamber (1) varies.

12. A device according to claim 5, in which the trap (11) is a cryogenic trap placed upstream of the recirculation pump (12).

13. A device according to claim 5, in which the trap (11) is a cryogenic trap comprising a heat conducting line (11a), with an upstream section (11b) crossed by heat conducting vanes (11c), with a downstream section (11d) filled with stainless steel links (11e) in contact with the line's wall, the line (11a) being crossed by the recirculation flow and being bathed on the outside in liquid nitrogen (11h).

14. A process for the cleaning of a process chamber, using a gas cleaning agent associated with a plasma source and by means of a device according to claim 1, comprising a process chamber (1) utilization stage, a process chamber (1) cleaning stage, and a device regeneration stage, characterized by the fact that said regeneration stage may take place at the same time as said utilization stage.

15. A process according to claim 14, in which said regeneration stage takes place during each utilization stage.

16. A process according to claim 14, in which, during the cleaning stage, a minority of the recycled gases pass up through all the pump's stages (12), leave through the return line (15) and join the bypassed outlet (12b), and the majority of the recycled gases pass directly through the bypassed outlet (12b).

17. A process according to claim 14, in which, during the regeneration stage, the valve (20) is open and the pump (12) bleeds the recirculation system (9), extracting the products resulting from cleaning condensed on the cryogenic trap (11) and discharging them into the line (16).
